(19) United States
(12) Patent Application Publication
(10) Pub. No.: US 2003/0061248 A1
(43) Pub. Date: Mar. 27, 2003

(54) Enhancing the reading of long pages in web browsers

(75) Inventors: Rabindranath Dutta, Austin, TX (US); Kamal Chandrakant Patel, Cedar Park, TX (US)

Correspondence Address: Marilyn Smith Dawkins, International Business Machines Corporation, Intellectual Property Law Department, 11400 Burnet Road, Internal Zip 4054, Austin, TX, 78758, US

(73) Assignee: International Business Machines Corporation

(21) Appl. No.: 09/844,341

(22) Filed: Apr. 27, 2001

(51) Int. Cl. G06F 17/00

(52) U.S. Cl. 707/526; 707/513

(57) ABSTRACT

A system, method and program further enable a browser to render long Web pages on a display screen of a computer in a way that enhances the reading of the pages. The browser, or a proxy server in communication with the browser, determines if the Web page being rendered is a long page. If it is, the page is rendered in at least two portions. Content, such as one or more words, lines, or a sentence, is visually identified, such as by highlighting, at the beginning of each portion which antecedes another portion and at the ending of each portion which precedes another portion. The visually identified content is redisplayed in conjunction with a rendering of an adjacent portion of the page in response to a selection of a page up or page down button by a user so that reading continuity between the displayed portions is visually enhanced.

### BACKGROUND OF THE INVENTION

1. Field of the Invention

This invention relates to accessing Web pages over the Internet, and more specifically to displaying pages having a length longer than what can be displayed on a display screen, and displaying those pages in a way that enhances the reading of those pages.

2. Description of the Related Art

As computational devices continue to proliferate throughout the world, there also continues to be an increase in the use of networks connecting these devices. Computational devices include large mainframe computers, workstations, personal computers, laptops and other portable devices including wireless telephones, personal digital assistants, automobile-based computers, etc. Such portable computational devices are also referred to as “pervasive” devices. The term “computer” or “computational device”, as used herein, may refer to any of such device which contains a processor and some type of memory.

The computational networks may be connected in any type of network including the Internet, an intranet, a local area network (LAN) or a wide area network (WAN). The networks connecting computational devices may be “wired” networks, formed using lines such as copper wire or fiber optic cable, wireless networks employing earth and/or satellite-based wireless transmission links, or combinations of wired and wireless network portions. Many such networks may be organized using a client/server architecture, in which “server” computational devices manage resources, such as files, peripheral devices, or processing power, which may be requested by “client” computational devices. “Proxy servers” can act on behalf of other machines, such as either clients or servers.

A widely used network is the Internet. The Internet, initially referred to as a collection of “interconnected networks”, is a set of computer networks, possibly dissimilar, joined together by means of gateways that handle data transfer and the conversion of messages from the sending network to the protocols used by the receiving network. When capitalized, the term “Internet” refers to the collection of networks and gateways that use the TCP/IP suite or protocols.

Currently, the most commonly employed method of transferring data over the Internet is to employ the World Wide Web environment, referred to herein as “the Web”. Other Internet resources exist for transferring information, such as File Transfer Protocol (FTP) and Gopher, but have not achieved the popularity of the Web. In the Web environment, servers and clients effect data transfer using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML).

In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”.

A browser is a program capable of submitting a request for information identified by an identifier, such as, for example, a URL, receiving the requested information or page identified by the URL, and rendering the requested page on a display.

A problem arises when the length of a requested page is such that the whole page cannot be completely displayed in a single instance within the browser window on the display at the client. “PageUp” and “PageDown” buttons are typically provided that enable a user to move between discrete portions of a page that are rendered separately on the screen at different instances. However, it is difficult to perceive the continuity between the discrete portions of long Web pages that are separately displayed. The formatting and pagination is not typically as precise in electronic documents as it is in non-electronic books where the pages are formatted and paginated extremely well. To the contrary, it is not unusual for the last word of a first displayed portion of a page to either appear in a middle of a line on the next displayed portion, or be a part of a line that was completely cut off from the displayed portion.

For example, FIG. 1A illustrates a first portion of a Web page where the word “no” is the last word of that portion. In the subsequent displayed portion, as shown in FIG. 1B, the word “no” appears at the end of the second line. As shown in FIG. 1B, it is difficult for a reader to maintain continuity in reading from one displayed screen of data to another when it is not obvious where the next word is located on the subsequent displayed portion.

The problems related to long pages become more prominent with more frequent use of PageUp and PageDown buttons in connection with the rise in use of small display screens that are associated with small Web clients including personal digital assistants (PDA's), Web phones, and other Web devices.

### SUMMARY OF THE INVENTION

The system, method and program of the invention improve the readability of a Web page in a browser. When a browser renders a portion of a page on the screen, the browser parses the HTML page to determine the first and last word(s) or line(s) or sentence(s) for the displayed discrete portion of the long page. If a PageUp or PageDown button is selected to display a previous or subsequent discrete portion, then the appropriate previously determined word(s), line(s), sentence(s) are redisplayed in association with the following discrete portion being displayed. The previous word(s), line(s) or sentence(s) can be redisplayed in a variety of forms and fashion for clearly delineating between the new information for that portion being currently displayed and any information repeated from a previous portion displayed. In this way, a reader can visually ascertain where to begin reading on a subsequent portion in order to maintain continuity between the portions.

More specifically, in an embodiment of the invention, when a browser displays a current portion of a page, the browser identifies the first and last word on the currently displayed portion such as by highlighting, shading, underlining, making bold, etc. If a PageUp or PageDown button is selected, then the corresponding next portion will show the same identification for that word. For example, if a PageUp button is selected, the first word from the previously displayed portion of the page will be identified and will appear somewhere near the bottom of the next portion to be displayed. If a PageDown button is selected, the last word that was identified from the previously displayed portion will appear somewhere near the top of the next portion to be displayed. In further embodiments, different identification types are used for the top and bottom of a current portion to aid the reader when the reader is paging up and down.

In another embodiment, text from one line, or a few lines, of a current portion are repeated on a next displayed portion. However, a line or dotted line or dashed line or a blank line or line space is used to delimit the material previously viewed on a previous portion and the new material on the next portion not previously seen on the previous portion. In other embodiments, the previously viewed lines on the next portion are identified by other means including an arrow at the side of the line or by highlighting or by other means.

### BRIEF DESCRIPTION OF THE DRAWINGS

For a more complete understanding of the present invention and the advantages thereof, reference should be made to the following Detailed Description taken in connection with the accompanying drawings in which:

FIG. 1A illustrates a first portion of a Web page;

FIG. 1B illustrates a second portion of the Web page of FIG. 1A resulting from a PageDown operation wherein the last word from the first page is difficult to locate on the second portion;

FIG. 2 illustrates a network environment in which a browser of a preferred embodiment of the invention resides at a client within the network;

FIG. 3 is a process flow diagram illustrating the logic of a preferred embodiment of the invention;

FIG. 4A illustrates a first portion of a Web page as shown in FIG. 1A but wherein the last word of the first portion is highlighted;

FIG. 4B illustrates a second portion of the Web page as shown in FIG. 1B but wherein the last word from the first portion remains highlighted and is now easier to locate on this second portion;

FIG. 5 illustrates a delineation between text that was also on a previous displayed portion and new text on this currently displayed portion of a page; and

FIG. 6 illustrates a block diagram of a browser program.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

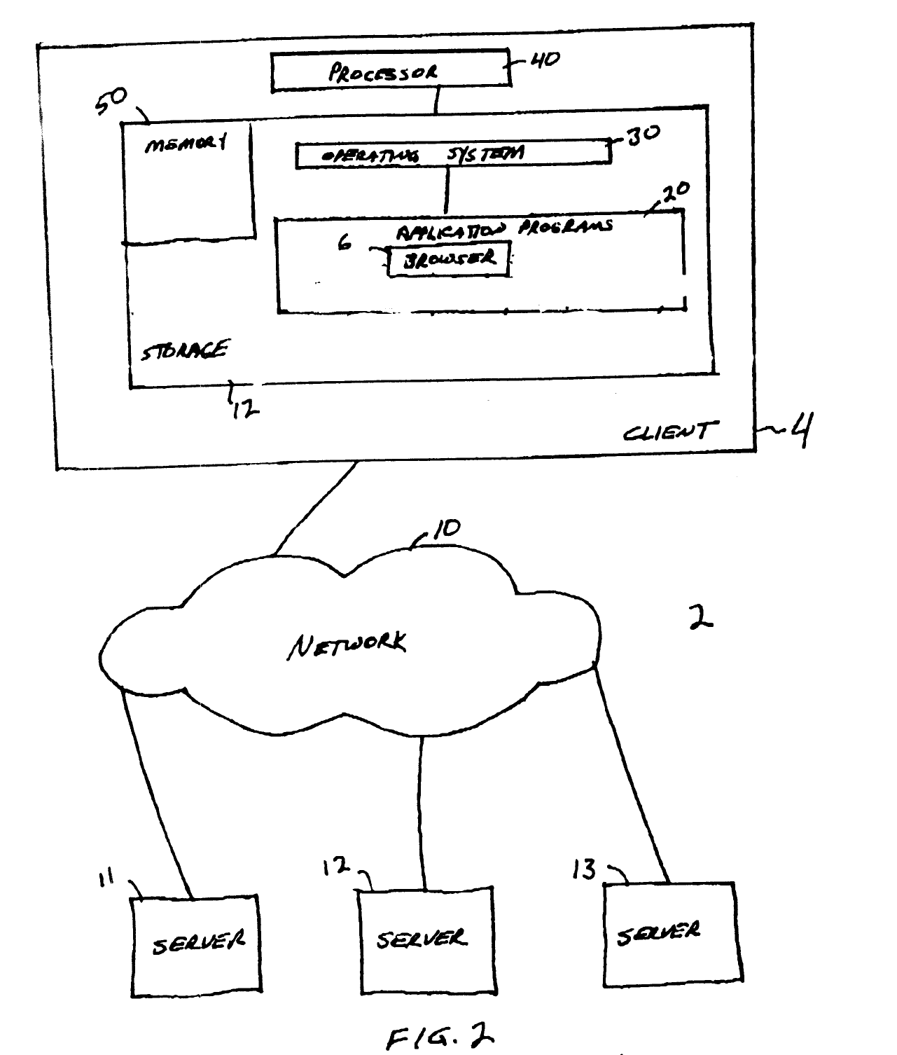

With reference to the figures, and in particular with reference now to FIG. 2, a high-level block diagram of a network computing environment in which a preferred embodiment of the present invention may be implemented is depicted. The computing environment 2 includes at least one client computer 4 including a browser program or viewer program 6, such as the Microsoft Explorer or Netscape Navigator, that is capable of retrieving files from servers 11, 12, 13 over a network 10. The client computer 4 may comprise any computer system known in the art capable of executing a browser program. The servers 11, 12, 13 may comprise any computer system known in the art capable of maintaining files and making such files accessible to remote computers. The browser 6 and servers 11, 12, 13 communicate using a document transfer protocol such as the Hypertext transfer Protocol (HTTP), or any other document transfer protocol known in the art, such as FTP, Gopher, WAIS, etc. The network 10 may be made up of a TCP/IP network, such as the Internet and World Wide Web, or any network system known in the art, e.g., LAN, Ethernet, WAN, System Area Network (SAN), Token Ring, etc.

The client computer 4 may be, but is not limited to, a personal computer, laptop, workstation, mainframe, or hand held computer including palmtops, personal digital assistant, smart phones, web enabled cellular phones, etc. Client computer includes processor 40 and memory 50. Memory 50 includes volatile or nonvolatile storage and/or any combination thereof. Volatile memory may be any suitable volatile memory device, e.g., RAM, DRAM, SRAM, etc. Nonvolatile memory may include storage space 12, e.g., via the use of hard disk drives, tapes, etc., for data, databases, and programs. The programs in memory include an operating system 30 and application programs 20 including a browser program 6. The browser program 6 displays a graphical user interface in which content from a file downloaded from one of the servers 11, 12, 13, such as a HTML page, is displayed. The browser GUI displays graphical buttons to perform operations related to the files downloaded from a server as further described herein.

The client computer 4 includes output devices (not shown) including a display for displaying the browser GUI and Web page and object content. The client computer also includes at least one input device (not shown) through which the user may enter input data to control the operation of the browser program 6, such as a keyboard, mouse, pen-stylus, touch sensitive screen, voice decoder for decoding voice commands, etc. In preferred embodiments, a user at the client computer 4 can input commands to control the browser program 6 through the graphical user interface (GUI) generated by the browser 6 or input device controls, such as keyboard keys, mouse buttons, touch pad regions, that are programmed to cause the browser to perform specific operations.

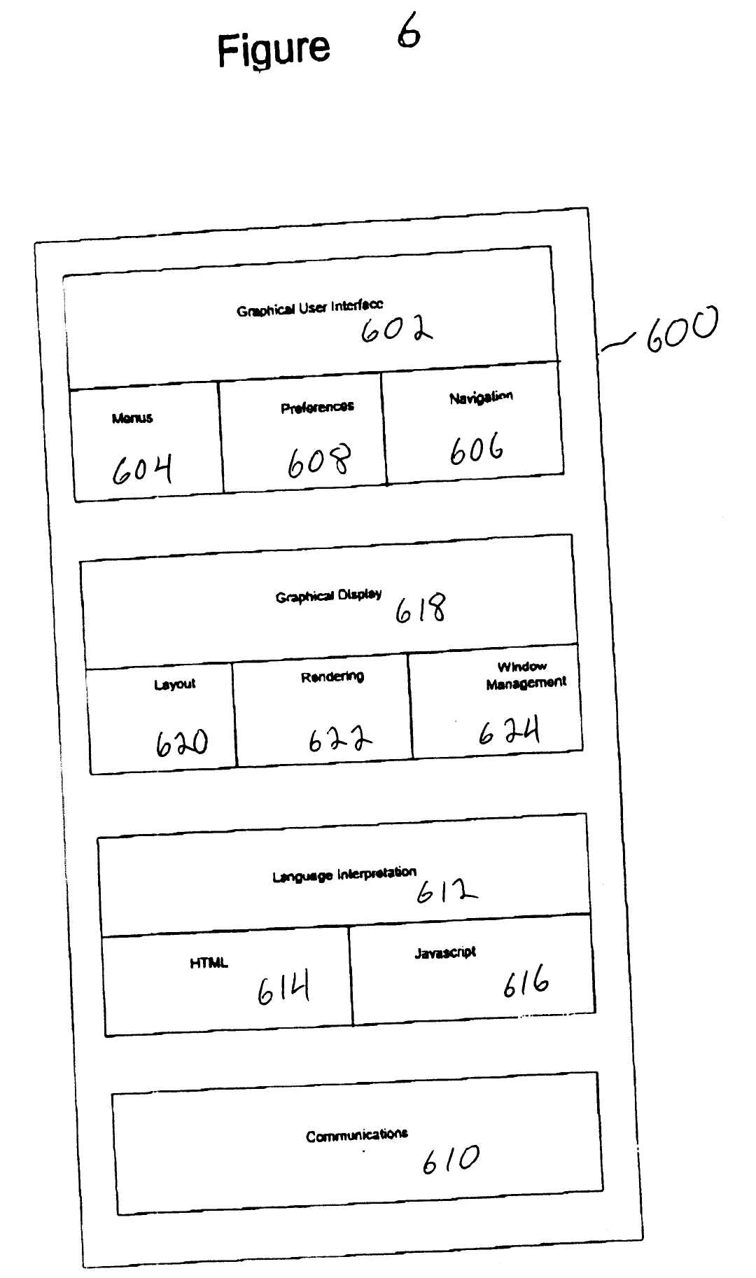

FIG. 6 is an exemplary block diagram of a browser program in accordance with a preferred embodiment of the present invention. A browser is an application used to navigate or view information or data in a network environment, such as the Internet or the World Wide Web.

In this example, browser 600 includes a user interface 602, which is a graphical user interface (GUI) that allows the user to interface or communicate with browser 600. This interface provides for selection of various functions through menus 604 and allows for navigation through navigation 606. For example, menu 604 may allow a user to perform various functions, such as saving a file, opening a new window, displaying a history, and entering a URL. Navigation 606 allows for a user to navigate various pages and to select Web sites for viewing. For example, navigation 606 may allow a user to see a previous page or a subsequent page relative to the present page. Preferences such as those illustrated in FIG. 6 may be set through preferences 608.

Communications 610 is the mechanism with which browser 600 receives documents and other resources from a network such as the Internet. Further, communications 610 is used to send or upload documents and resources onto a network. In the depicted example, communications 610 uses HTTP. Other protocols may be used depending on the implementation. Documents that are received by browser 600 are processed by language interpretation 612, which includes an HTML unit 614 and a JavaScript unit 616. Language interpretation 612 will process a document for presentation on graphical display 618. In particular, HTML statements are processed by HTML unit 614 for presentation while JavaScript statements are processed by JavaScript unit 616.

Graphical display 618 includes layout unit 620, rendering unit 622, and window management 624. These units are involved in presenting Web pages to a user based on results from language interpretation 612.

Browser 600 is presented as an example of a browser program in which the present invention may be embodied. Browser 600 is not meant to imply architectural limitations to the present invention. Presently available browsers may include additional functions not shown or may omit functions shown in browser 600. A browser may be any application that is used to search for and display content in a network environment. Browser 600 may be implemented using known browser applications, such as Netscape Navigator or Microsoft Internet Explorer. Netscape Navigator is available from Netscape Communications Corporation while Microsoft Internet Explorer is available from Microsoft Corporation.

The exemplary embodiments shown in FIGS. 2 and 6 are provided solely for the purposes of explaining the preferred embodiments of the invention; and those skilled in the art will recognize that numerous variations are possible, both in form and function.

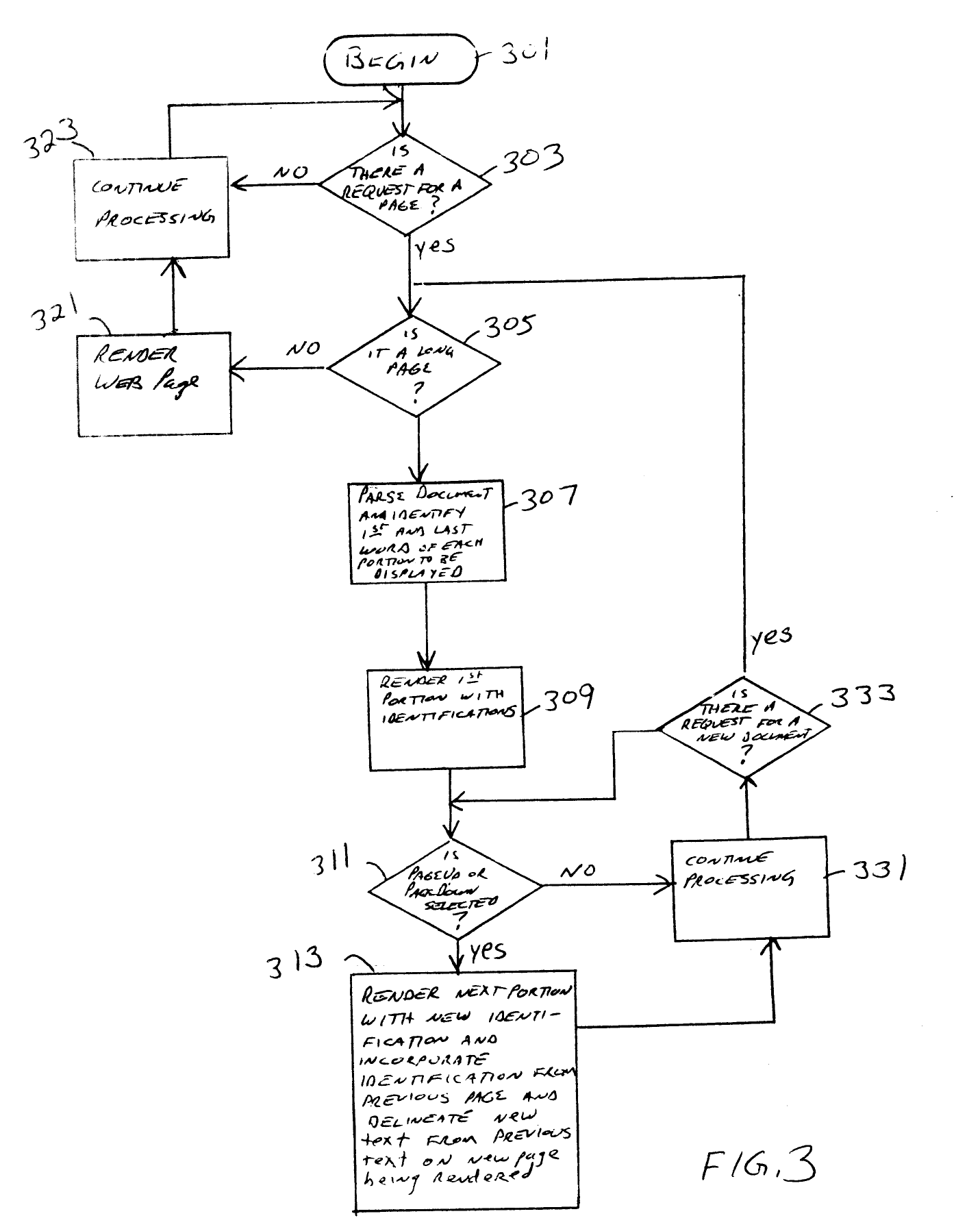

FIG. 3 is a process flow diagram illustrating the logic of a preferred embodiment of the invention. The process begins at 301 when the browser program is executed. A processing loop continues 323 until a request for a document, e.g., a Web page, is made, 303. IF a request for a Web page is made, the browser running at the client, or a proxy server communicatively connected to the browser, determines if it is a “long” Web page. That is, a determination is made as to whether or not the complete content of the requested Web page can be displayed within the browser window as limited by the screen real estate of the display for the client on which the browser is running. If the complete page is too long to be completely displayed at one instance within the boundaries of the browser GUI, then it is considered to be a long Web page. if it is determined that the Web page is not a long Web page 305, then the requested page is rendered 321 and processing continues 323. If it is determined that the requested page is a long page 305, then the page is parsed to identify the first and last word of each portion of the page to be displayed 307. The first portion is rendered with the first and last words visually identified 309, such as by highlight or by other means. A determination is made as to whether or not a PageUp or PageDown button is selected 311. If neither of the PageUp and PageDown buttons have been selected, then processing continues 331 until the PageUp or PageDown button is selected 311 or until there is a request for a new document 333. If either the PageUp or PageDown button is selected 311, then the following occurs as shown at block 313. The next appropriate portion (depending upon whether PageUp or PageDown was selected) is rendered with the new identifications visually indicated. When rendered, this next portion also incorporates visual indications of the identifications made for the previously rendered portion. When displaying this next portion, the browser also visually delineates any new information that is currently displayed from any information being currently displayed that was also previously displayed with the previous portion.

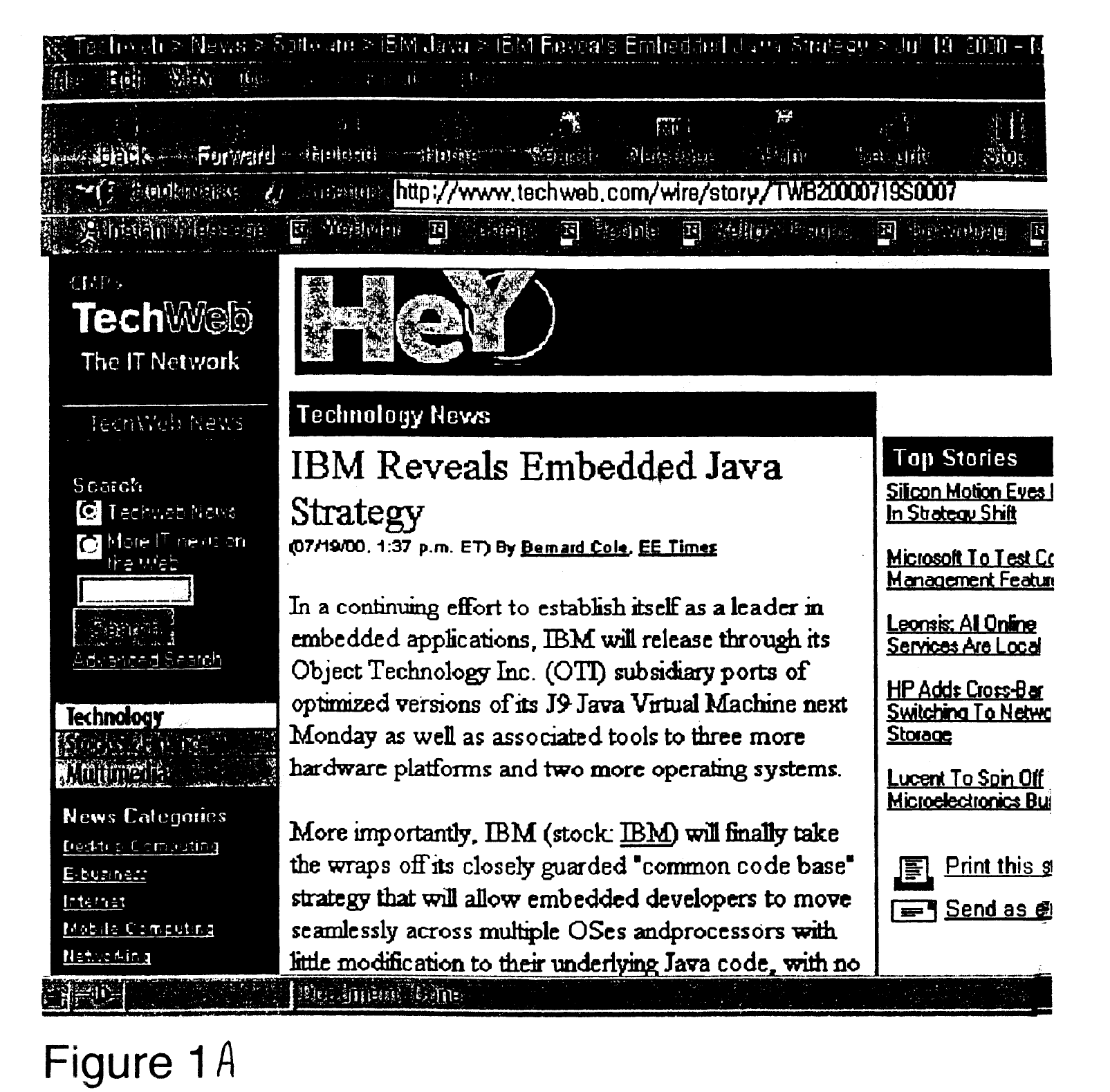

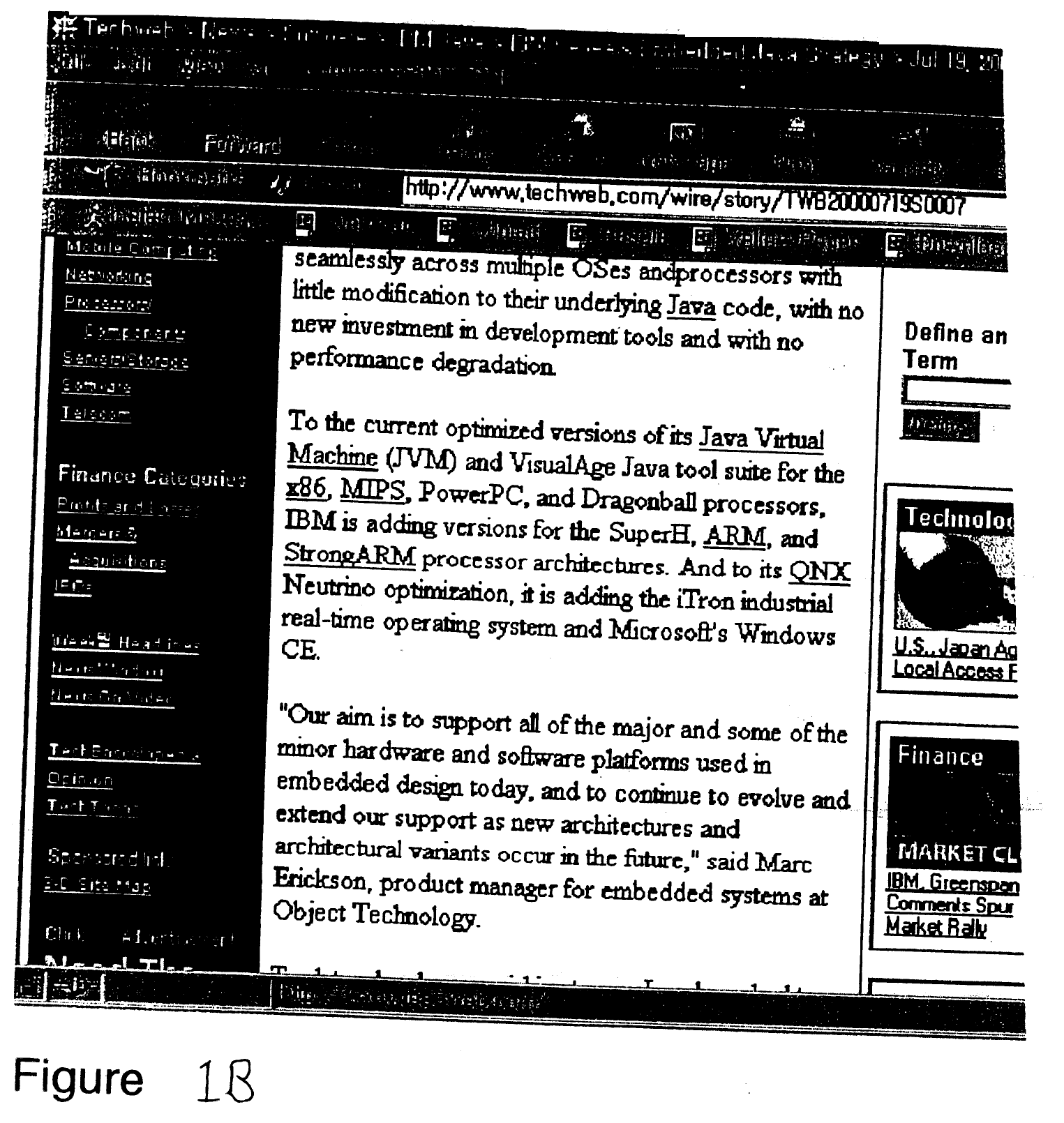

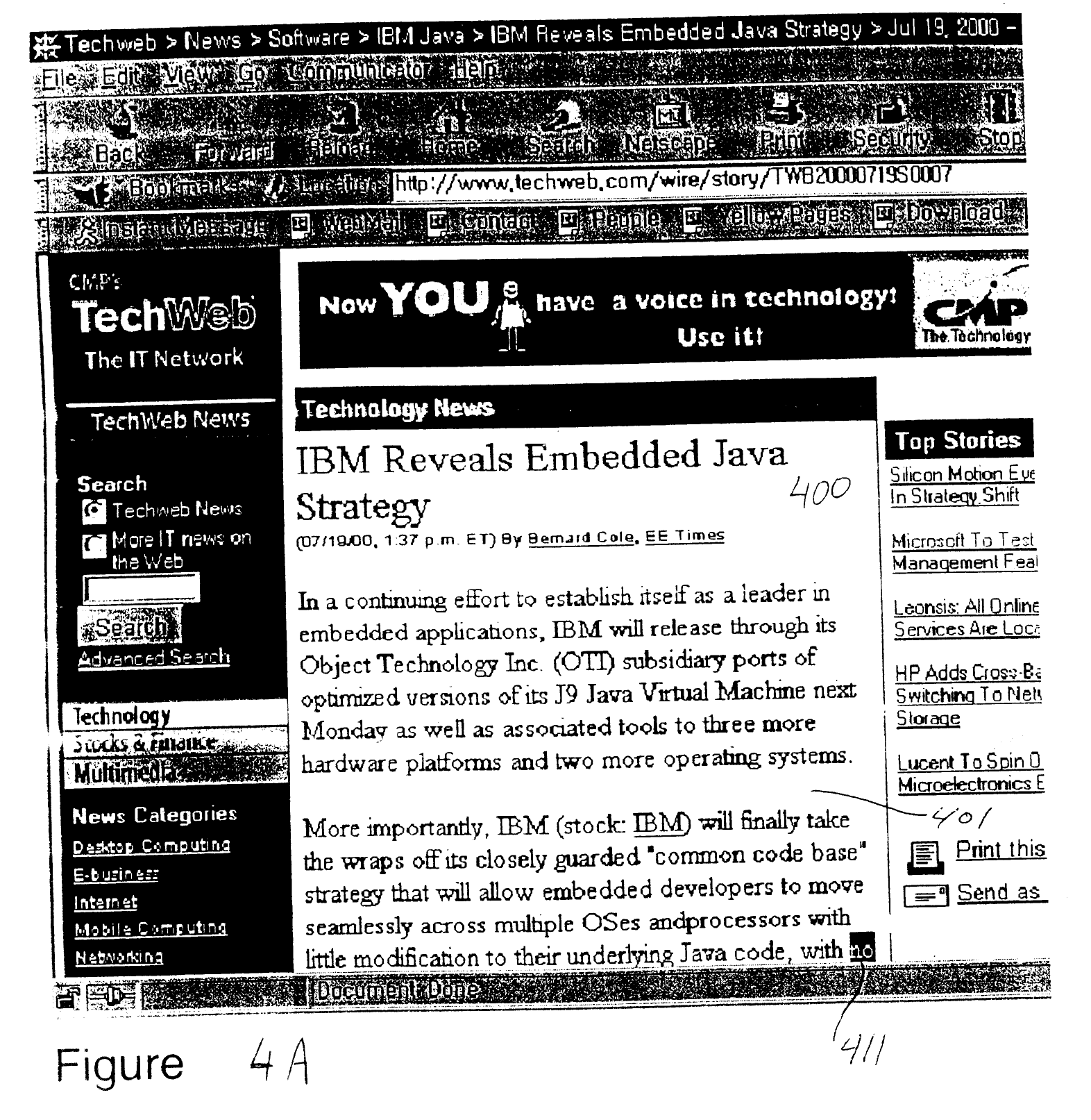

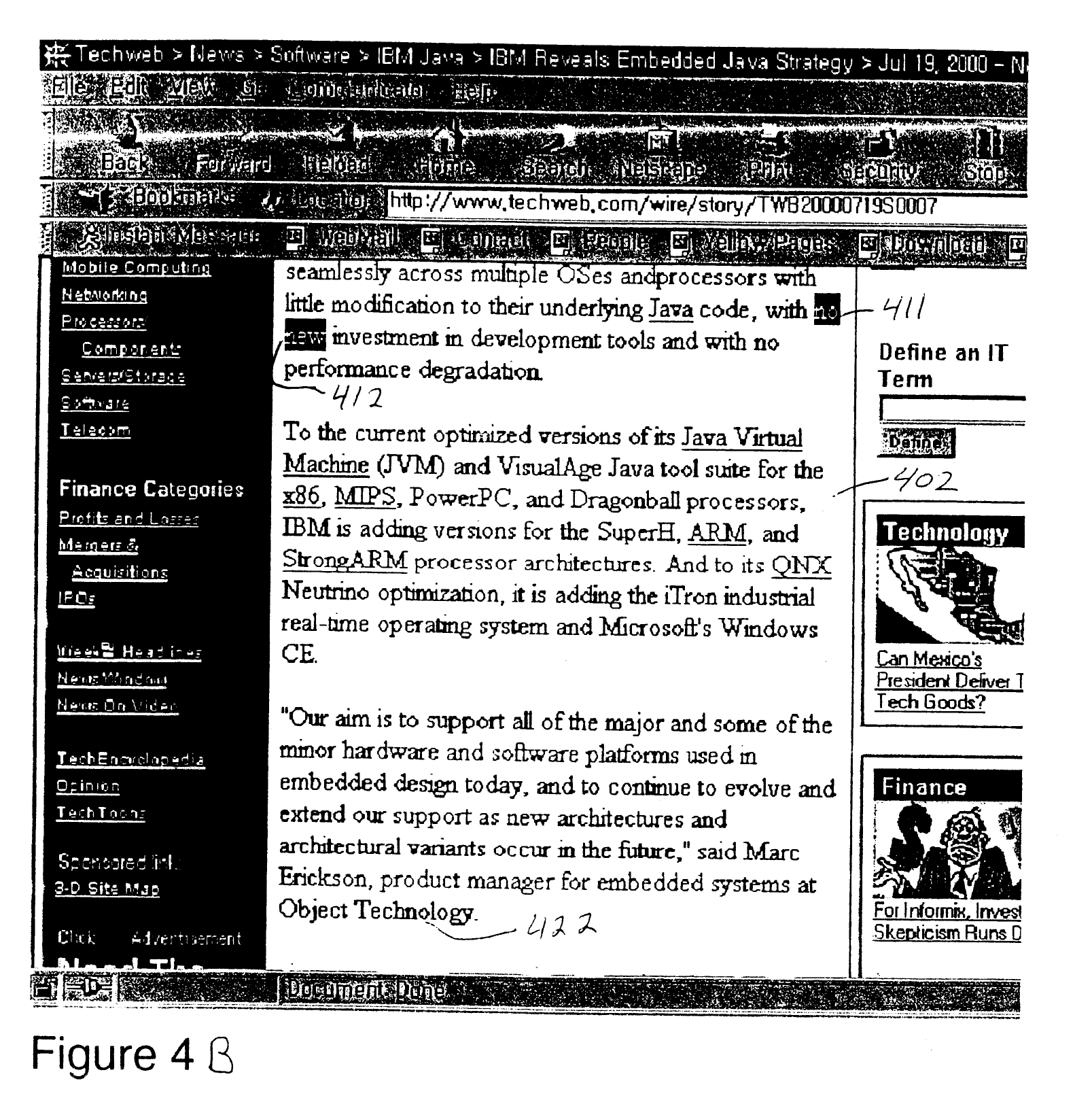

FIG. 4A illustrates a first portion 401 of a Web page 400. Web page 400 is the same Web page as shown in FIG. 1A. However, utilizing a preferred embodiment of the invention, FIG. 4A shows the last word “no” 411 as being highlighted. Other embodiments may identify the last word by other means such as by shading, underlining, making bold, etc.

FIG. 4B illustrates a second portion 402 of the Web page 400 as shown in FIG. 1B but wherein the last word 411 from the first portion 401 of FIG. 4A remains highlighted and is now easier to locate on this second portion 402. This enables the reader to continue reading the document without a break in continuity, i.e., without trying to locate where the reader left off from the previous portions of the page. It should be noted that the first new word “new” 412 of this second portion 402 is highlighted, also. In some embodiments, the two words 411, 412 are identified using two different identification means (for example, having each word in a different color, or having one bold and the other italicized, etc.) The two different identification means aid the user in knowing where the previous portion ended and where the new portion picks up. This is helpful not only in providing the reader continuity in reading from one portion to the other, but in providing an indication to the user of this first word if the user selects a PageUp button wherein this first word 412 may be then the last word displayed in a subsequently displayed portion of a page. In a preferred embodiment, if there were yet at least another portion to be displayed after this second portion, then the last word “Technology” 422 of this portion 402 would also be highlighted. As such, if the PageDown button were to be selected, then the word “Technology” would be displayed on a subsequent third portion in a similar manner as the word “no” 411 was displayed on this second portion 402.

It should be noted that although the invention is described above showing only individual last and first words identified in the various portions of the page, other identifications may also be made, including but not limited to identifying a group of words, or sentences or lines at the beginning and end of the various page portions. In other embodiments, the previously viewed lines that were a part of a previously displayed portion of the page may be identified in a currently displayed portion by an arrow or other marking off to one or both sides of the line.

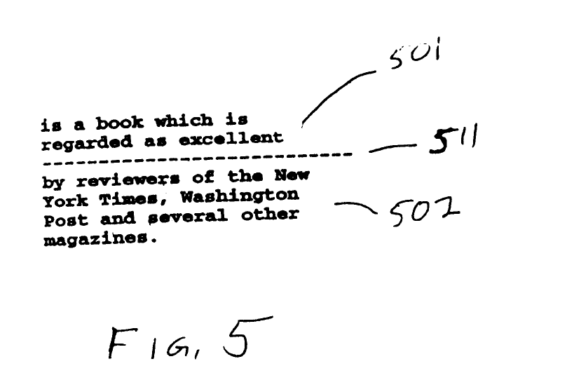

FIG. 5 illustrates a delineation between text 501 that was also on a previously displayed portion of a page and new text 502 on a currently displayed portion of the page. The delineation may be made by inserting a line 511 or by other means such as a dotted, solid, or dashed line, or blank lines or spaces.

As herein described, the system, method and program of the invention further enable a browser to render long Web pages on a display screen of a computer in a way that enhances the reading of the pages. A long page is a page that is too long to be completely rendered at one given instance on the display screen. The browser, or a proxy server in communication with the browser, determines if the whole page can be rendered in one instance within the browser GUI on the display screen. If not, the page is rendered in at least two portions. Content, such as one or more words, lines, or a sentence, is visually identified, such as by highlighting, at the beginning of each portion which antecedes another portion, and at the ending of each portion which precedes another portion. The visually identified content is redisplayed in conjunction with a rendering of an adjacent portion of the page in response to a selection of a page up or page down button by a user. As such each portion rendered contains some visually identified content from a previously rendered adjacent portion.

The preferred embodiments may be implemented as a method, system, or article of manufacture using standard programming and/or engineering techniques to produce software, firmware, hardware, or any combination thereof. The term “article of manufacture” (or alternatively, “computer program product”) as used herein is intended to encompass data, instructions, program code, and/or one or more computer programs, and/or data files accessible from one or more computer usable devices, carriers, or media. Examples of computer usable mediums include, but are not limited to: nonvolatile, hard-coded type mediums such as CD-ROMs, DVDs, read only memories (ROMs) or erasable, electrically programmable read only memories (EEPROMs), recordable type mediums such as floppy disks, hard disk drives and CD-RW and DVD-RW disks, and transmission type mediums such as digital and analog communication links, or any signal bearing media. As such, the functionality of the above described embodiments of the invention can be implemented in hardware in a computer system and/or in software executable in a processor, namely, as a set of instructions (program code) in a code module resident in the random access memory of the computer. Until required by the computer, the set of instructions may be stored in another computer memory, for example, in a hard disk drive, or in a removable memory such as an optical disk (for use in a CD ROM) or a floppy disk (for eventual use in a floppy disk drive), or downloaded via the Internet or other computer network, as discussed above. The present invention applies equally regardless of the particular type of signal-bearing media utilized.

The foregoing description of the preferred embodiments of the invention has been presented for the purposes of illustration and description. It is not intended to be exhaustive or to limit the invention to the precise form disclosed. Many modification and variations are possible in light of the above teaching. For example, although preferred embodiments of the invention have been described in terms of the Internet, other network environments including but not limited to wide area networks, intranets, and dial up connectivity systems using any network protocol that provides basic data transfer mechanisms may be used.

It is intended that the scope of the invention be limited not by this detailed description, but rather by the claims appended hereto. The above specification, examples and data provide a complete description of the manufacture and use of the system, method, and article of manufacture, i.e., computer program product, of the invention. Since many embodiments of the invention can be made without departing from the spirit and scope of the invention, the invention resides in the claims hereinafter appended.

Having thus described the invention, what we claim as new and desire to secure by Letters Patent is set forth in the following claims:

1. A method for rendering a Web page on a display screen of a computer executing a browser program, comprising:
determining if a whole page can be rendered in one instance within the browser GUI on the display screen;
rendering the whole page in at least two portions if it is determined that the page can not be rendered in the one instance;
visually identifying content at a boundary of each portion of the page when each portion is rendered; and
redisplaying the visually identified content in conjunction with a rendering of an adjacent portion of the page.

2. The method of claim 1 wherein the content at a boundary is one of a) at least one word, b) at least one line, and c) at least one sentence, at an ending of each portion which precedes another portion.

3. The method of claim 1 wherein the content at a boundary is one of a) at least one word, b) at least one line, and c) at least one sentence, at a beginning of each portion which antecedes another portion.

4. The method of claim 1 wherein visually identifying comprises at least one of highlighting, making bold, italicizing, shading, inserting a marker, and separating by at least one of a visual line, a space, a line space.

5. The method of claim 1 wherein redisplaying the visually identified content in conjunction with a rendering of an adjacent portion of the page is in response to at least one of a page up selection and a page down selection.

6. The method of claim 1 wherein each portion rendered contains some content from an adjacent portion.

7. A computer system having a display and having means for rendering a Web page on the display, comprising:
means for determining if a whole page can be rendered in one instance within the browser GUI on the display screen;
means for rendering the whole page in at least two portions if it is determined that the page can not be rendered in the one instance;
means for visually identifying content at a boundary of each portion of the page when each portion is rendered; and
means for redisplaying the visually identified content in conjunction with a rendering of an adjacent portion of the page.

8. The system of claim 7 wherein the content at a boundary is one of a) at least one word, b) at least one line, and c) at least one sentence, at an ending of each portion which precedes another portion.

9. The system of claim 7 wherein the content at a boundary is one of a) at least one word, b) at least one line, and c) at least one sentence, at a beginning of each portion which antecedes another portion.

10. The system of claim 7 wherein the means for visually identifying comprises means for at least one of highlighting, making bold, italicizing, shading, inserting a marker and separating by at least one of a visual line, a space, a line space.

11. The system of claim 7 wherein the means for redisplaying the visually identified content in conjunction with a rendering of an adjacent portion of the page is in response to at least one of a page up selection and a page down selection.

12. A computer system comprising:
a processor;
memory;
a display;
a browser program, stored in the memory and executable by the processor, having instruction means for rendering a Web page on the display, further comprising:
instruction means for determining if a whole page can be rendered in one instance within the browser GUI on a screen of the display;
instruction means for rendering the whole page in at least two portions if it is determined that the page can not be rendered in the one instance;
instruction means for visually identifying content at a boundary of each portion of the page when each portion is rendered; and
instruction means for redisplaying the visually identified content in conjunction with a rendering of an adjacent portion of the page.

13. A computer program, on a computer usable medium, having computer readable program code means for rendering a Web page on a display screen of a computer, comprising:
instruction means for determining if a whole page can be rendered in one instance within the browser GUI on the display screen;
instruction means for causing a rendering of the whole page in at least two portions if it is determined that the page can not be rendered in the one instance;
instruction means for causing a visual identification of content at a boundary of each portion of the page when each portion is rendered; and
instruction means for causing a redisplay of the visually identified content in conjunction with a rendering of an adjacent portion of the page.

14. A method for enabling a rendering of a requested Web page on a display screen of a communicatively connected computer, comprising:
receiving a requested Web page over a network from a server;
determining if a whole page can be rendered in one instance within the browser GUI on the display screen of a communicatively connected specified client;
enabling the whole page to be rendered in at least two portions if it is determined that the page can not be rendered in the one instance;
visually identifying content at a boundary of each portion of the page;
combining the visually identified content of a given page with an adjacent page of content;
sending the portions to the specified client for rendering a first portion and each subsequent portion separately in response to at least one of a page up selection and page down selection by a user.

15. A computer system, comprising:
means for receiving a requested Web page over a network from a server;
means for determining if a whole page can be rendered in one instance within the browser GUI on the display screen of a specified client;
means for enabling the whole page to be rendered in at least two portions if it is determined that the page can not be rendered in the one instance;
means for visually identifying content at a boundary of each portion of the page;
means for combining the visually identified content of a given page with an adjacent page of content;
means for sending the portions to the specified client for rendering a first portion and each subsequent portion separately in response to at least one of a page up selection and page down selection by a user.

16. A computer program, on a computer usable medium, having computer readable program code means, comprising:
instruction means for enabling a receipt of a requested Web page over a network from a server;
instruction means for determining if a whole page can be rendered in one instance within the browser GUI on the display screen of a specified client;
instruction means for enabling the whole page to be rendered in at least two portions if it is determined that the page can not be rendered in the one instance;
instruction means for visually identifying content at a boundary of each portion of the page;
instruction means for combining the visually identified content of a given page with an adjacent page of content;
instruction means for sending the portions to the specified client for rendering a first portion and each subsequent portion separately in response to at least one of a page up selection and page down selection by a user.
